(19) United States
(12) Patent Application Publication
(10) Pub. No.: US 2007/0180771 A1
(43) Pub. Date: Aug. 9, 2007

(54) Security window or door in a burglar-retardant embodiment

(75) Inventor: Heinrich Salzer, Marburg (DE)

Correspondence Address: WILLIAM COLLARD;COLLARD & ROE, P.C., 1077 NORTHERN BOULEVARD, ROSLYN, NY, 11576, US

(73) Assignee: SALZER SICHERHEITSTECHNIK GmbH

(21) Appl. No.: 11/702,335

(22) Filed: Feb. 5, 2007

(30) Foreign Application Priority Data
Feb. 9, 2006 (EP) 06 002 600.2

(51) Int. Cl. E05D 15/28

(52) U.S. Cl. 49/246

(57) ABSTRACT

The present invention relates to a security window (1) or door in a burglar-retardant embodiment according to the preamble of claim 1. In order to obtain the burglar-retardant properties in the tilted position (7), at least one connecting rod block (15, 15′, 15″) is situated on at least one casement leg (F1 through F4), which prevents a displacement of the assigned section (13.1 through 13.4) of the connecting rod (11) when the casement (3) is in the tilted position (7) or solely allows a displacement path which is required in the closed position (5) of the casement (3) to disengage the scissor hinge (8) and a bearing element (9, 9′) on the casement (3) or the frame (2).

### INTRODUCTION

The present invention relates to a security window or door in a burglar-retardant embodiment according to the preamble of claim 1.

Security windows or doors which are distinguished in the closed state by a high break-in security and/or burglar retardance are generally known. The high break-in security is achieved by an especially stable embodiment of the frame and by the use of a security glass having great impact security. In turning, tilting, or turn-tilt windows and/or in doors which are equipped with a frame permanently connectable to a building part and a casement which accommodates a filling, high demands are placed on the connection elements (locks) between frame and casement. Compared to simple windows or doors, a significantly higher number of connection elements is used, which accordingly have a small interval to one another around the circumference of the frame and, furthermore, have especially high strength and/or stability.

The disadvantage of these security windows or doors is their inadequate burglar retardance in the tilted state. An unauthorized person may achieve access to actuating handles located in the interior, which he may thus move, with or without the use of aids, through the opening gap produced in the tilted position, by which access to the interior may be achieved. In order to counteract this disadvantage, lockable actuating handles may be used, whose position in the locked state is not changeable.

However, the possibility also results through the opening gap for an unauthorized person to manipulate or destroy locking elements which are located between the frame and the casement in such a way that the person achieves access to the interior. A typically peripheral connecting rod which is situated on the casement legs and is coupled by corner deflectors, to which the connection elements and/or locking elements are typically attached, may be destroyed at the corner deflectors, for example, and the locking elements, which are engaged in the tilted state, may be unlocked by a forcible displacement of the detached section of the connecting rod.

Finally, the possibility remains to a burglar of destroying a scissor hinge delimiting the upper opening gap, which is typically situated between the upper frame and the casement leg, or to take it out of its guide by manipulation, through which he is capable of rotating the casement with filling completely around the horizontal tilt axis situated on the lower frame leg or even removing it from the frame.

An explosion-retardant window, whose explosion-retardant properties are to be maintained even in the tilted state of the window, is disclosed in European Patent Application EP 1 516 996 A2. The window described therein has at least one security scissor hinge between the upper frame leg and casement leg instead of a typically implemented turn-tilt scissor hinge, which is implemented as extremely stable and, in addition, is equipped with bearing elements which are seated in a formfitting way in chambers formed by the frame elements. The destruction or manipulation of the scissor hinge per se is made significantly more difficult in the tilted state of the window, but sabotage of the locking elements located along the frame legs is not to be precluded.

### OBJECT

It is the object of the present invention to provide a security window or door whose burglar-retardant properties are maintained in the tilted position.

### ACHIEVEMENT OF THE OBJECT

This object is achieved according to the present invention in that at least one connecting rod block on at least one casement leg prevents a displacement of the assigned section of the connecting rod when the casement is located in the tilted position, or only allows a displacement path which is required in the closed position of the casement to disengage the scissor hinge and a bearing element on the casement or the frame.

A connecting rod block may be situated on an upper horizontal casement leg, on one or both lateral vertical casement legs, and/or on a lower horizontal casement leg, the different connecting rod blocks being able to differ from one another in their construction and mode of operation. Situating connecting rod blocks prevents the position of the connecting rod and thus the position of the locking elements coupled thereto from being able to be changed to such an extent, when a window is in the tilted position, that they may be disengaged and the window may be completely opened. By situating connecting rod blocks on all casement legs, the locking elements may be secured from manipulation for every section of the connecting rod, each of which is assigned to a casement leg. This means that even after forcible actuation of the actuating handle or forcible destruction of the corner deflectors between the individual sections of the connecting rod, each section is secured per se.

Furthermore, a window having the properties according to the present invention also has explosion-retardant properties even in the tilted state, in addition to a burglar-retardant effect.

The connecting rod blocks may be constructed in one piece or in multiple parts. A one-piece connecting rod block may comprise one element, a plate, which is attached permanently and non-removably to a specific point on the casement and covers a partial area of the connecting rod, for example. The connecting rod block typically acts together with a fitting element which is provided on the connecting rod in any case and is permanently connected thereto, such as a bearing element for the scissor hinge. The element may be made nonremovable, for example, in the event of attachment using screws, by drilling out the screws after mounting, for example, or covering them with a ball, so that the element is secured from dismounting. A connecting rod block implemented in this way lies over the connecting rod, but no connection exists thereto, so that a displacement of the connecting rod around the circumference in the event of an exertion of a rotational movement of the actuating handle is not restricted. This type of the connecting rod block is always activated, independently of the position of the casement.

A connecting rod block may also advantageously be constructed in two parts. In this case, a connecting rod block comprises a block element coupled to a section of the connecting rod and a block element which works together therewith and is permanently connected to an assigned frame leg—preferably a vertical frame leg. The block elements may be disengaged by transferring the casement from the tilted position into the closed position, so that the connecting rod is displaceable as usual in the latter position by the actuating handle in order to be able to bring the casement into the turning position, for example.

The block element which is attached permanently to the frame may be implemented as a projection, for example, and the block element attached to the casement may be implemented as a lug, which is seated on the connecting rod and is therefore movable therewith. The position of the projection permanently attached to the frame is selected in such a way that in the closed position of the window, a movement of the connecting rod having the lug located thereon as a result of the rotation of the actuating handle is not obstructed. In the tilted position of the window, in contrast, the lug of the connecting rod block lies in the plane of the projection, so that the two elements would hit one another in the event of a displacement of the connecting rod around the circumference of the window. A connecting rod block constructed in this way is solely activated in the tilted state of the window—quasi-automatically.

According to one embodiment of the connecting rod block, the at least one block element permanently connected to a frame leg projects beyond the plane of the frame facing toward the interior and is covered in the closed position of the casement by an edge strip of the assigned vertical casement leg. This makes it possible for the particular block elements of frame and casement not to lie in one plane in the closed position, but rather only reach one plane after a movement of the casement into the tilted position and thus cause the effect of the blocking. Furthermore, the appearance of the window is not negatively changed by covering the block element.

Furthermore, at least the section of the connecting rod which is assigned to the casement leg on which the at least one scissor hinge is situated is at least partially covered by a connecting rod block. In addition to the function as a displacement block in the area of the comparatively large opening gap at the top of the casement, the covering also fulfills a protective function in that the connecting rod is partially not even reachable for manipulations.

It is advantageous if the connecting rod is covered in the area between two corner deflectors using at least one connecting rod block which is permanently connected to the casement in such a way that the connecting rod is displaceable in relation to the casement under the connecting rod block.

In a further embodiment, the connecting rod block is L-shaped in cross-section and is connected in the area of a short L-leg to the casement leg laterally neighboring the connecting rod, preferably on the side facing toward the exterior of the building. The long L-leg covers the connecting rod over its entire width.

An especially burglar-retardant effect is achieved in that the at least one connecting rod block also prevents a displacement of the casement in a direction parallel to the plane of the filling and perpendicular to the assigned connecting rod in the tilted position of the casement.

Furthermore, it is advantageous if the end of the scissor hinge facing toward the casement is covered by a covering connected to the casement. The scissor hinge may be covered by extending the scissor hinge beyond its mushroom head or by a covering attached to the casement. The covering, which either forms an integral part of the casement or is connected thereto later, prevents unauthorized persons from being able to lever the scissor hinge outward out of its bearing element using a suitable aid, the mushroom head being able to be cut off forcibly. Destroying the scissor hinge and providing an entry opening in this way are thus made more difficult.

Finally, in an especially advantageous embodiment of the security window, the scissor hinge is a security scissor hinge, bearing elements of the security scissor hinge being connected to inserts in chambers of both the casement and the frame. Destroying the scissor hinge and providing an entry capability in this way may thus also be counteracted.

### EXEMPLARY EMBODIMENT

The present invention is explained in greater detail in the following on the basis of an exemplary embodiment, which is illustrated in the figures of the drawing. These figures show, in the installed state,

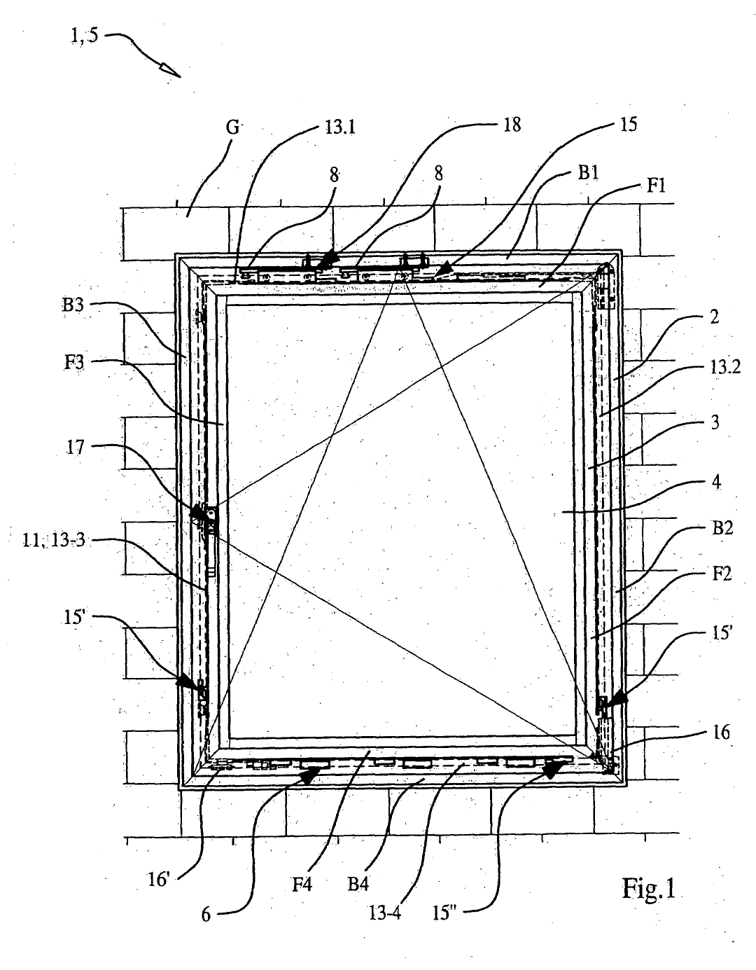

FIG. 1 an external view of a window according to the present invention

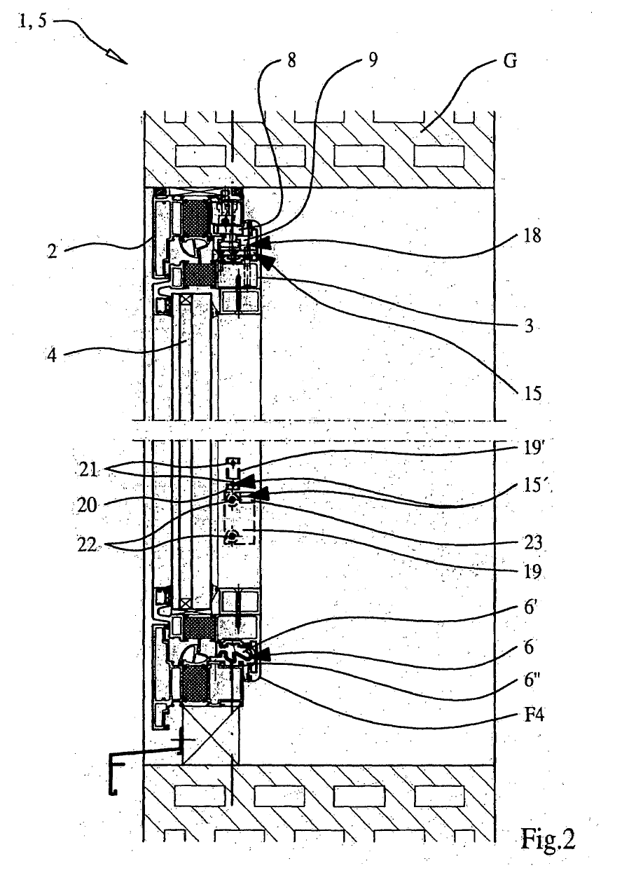

FIG. 2 a vertical section through this window in the closed state,

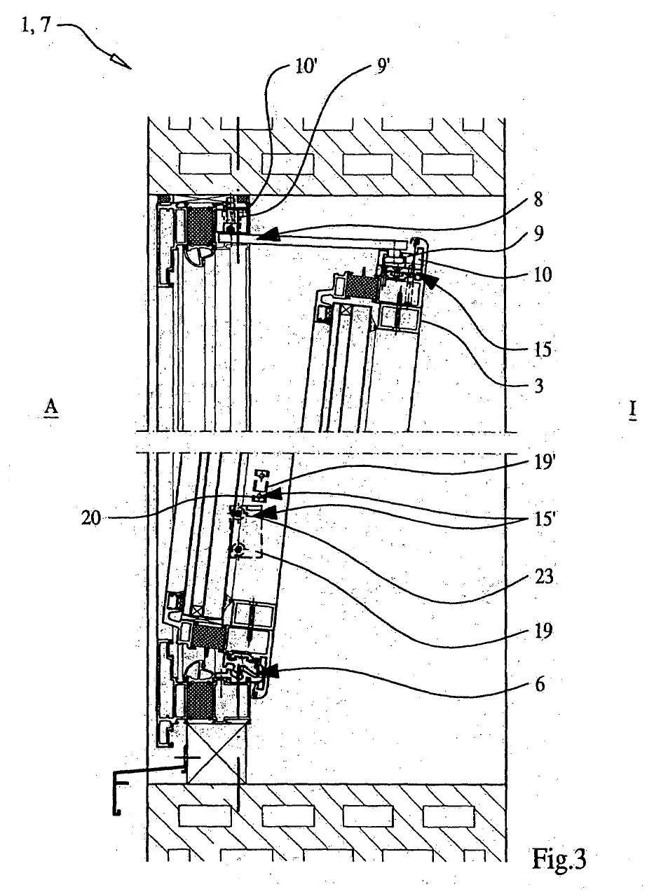

FIG. 3 a vertical section through this window in the tilted state,

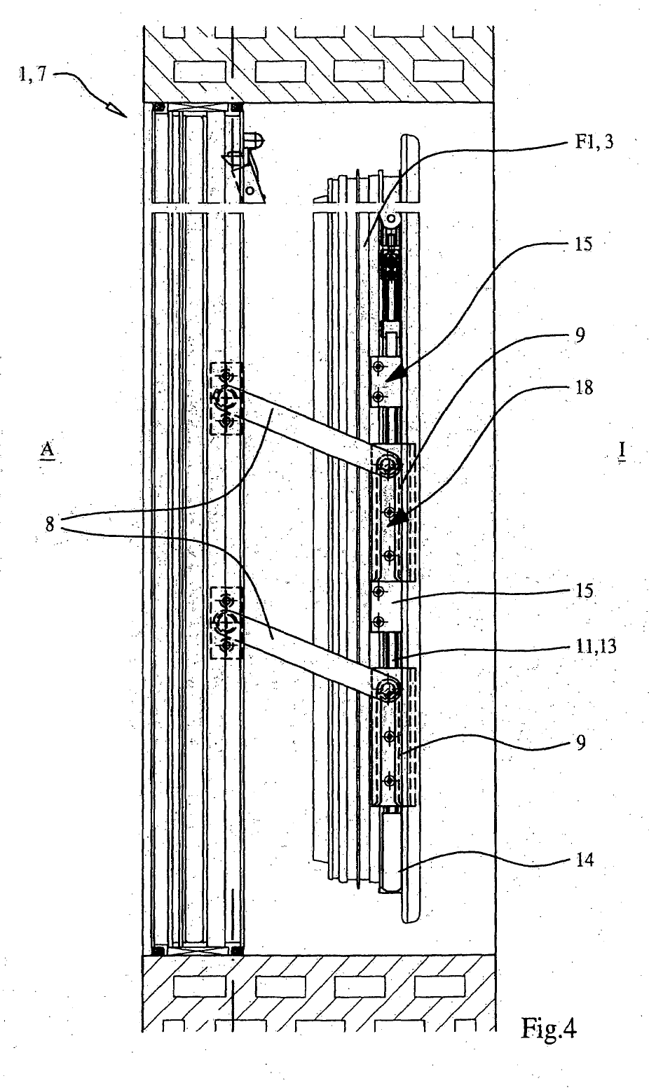

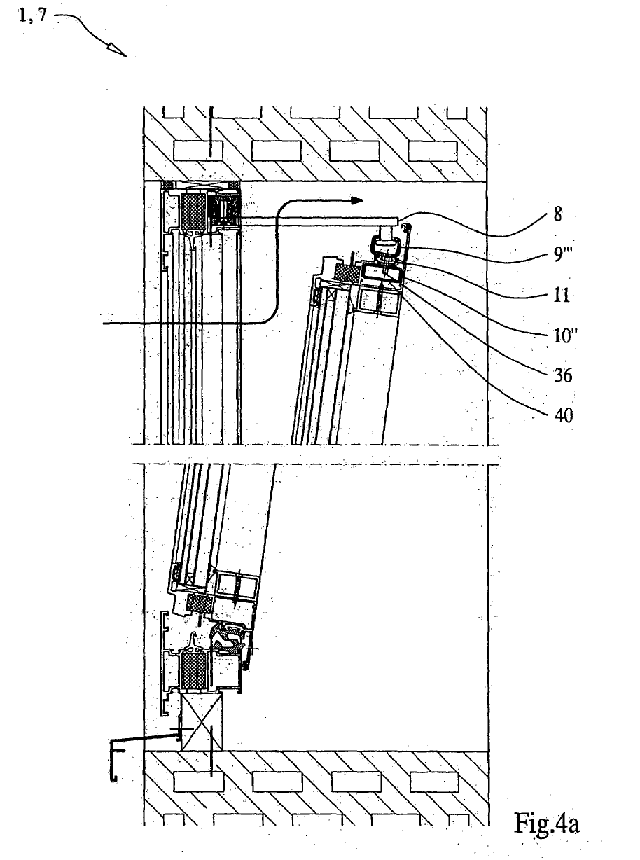

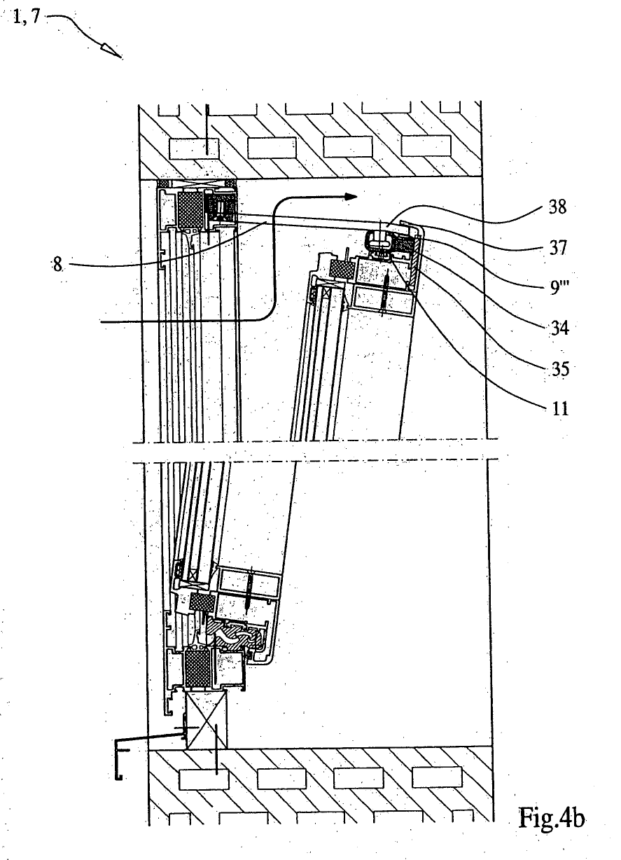

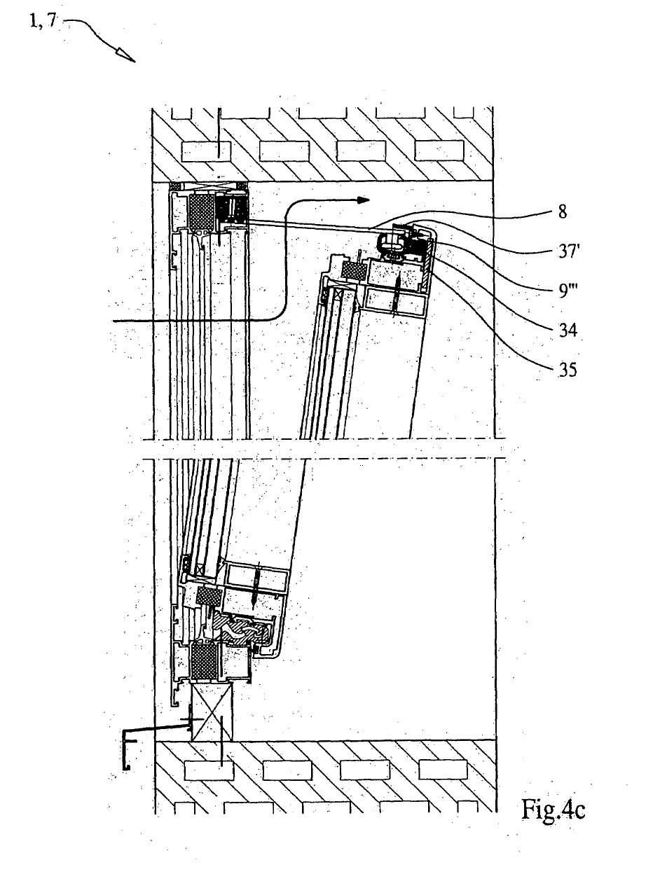

FIG. 4 a top view of this window in the tilted state,

FIG. 4a a vertical section through a window in the tilted state having an alternatively implemented casement profile,

FIG. 4b a vertical section through a window in the tilted state having a further alternatively implemented casement profile,

FIG. 4c a vertical section through a window in the tilted state having a further alternatively implemented casement profile,

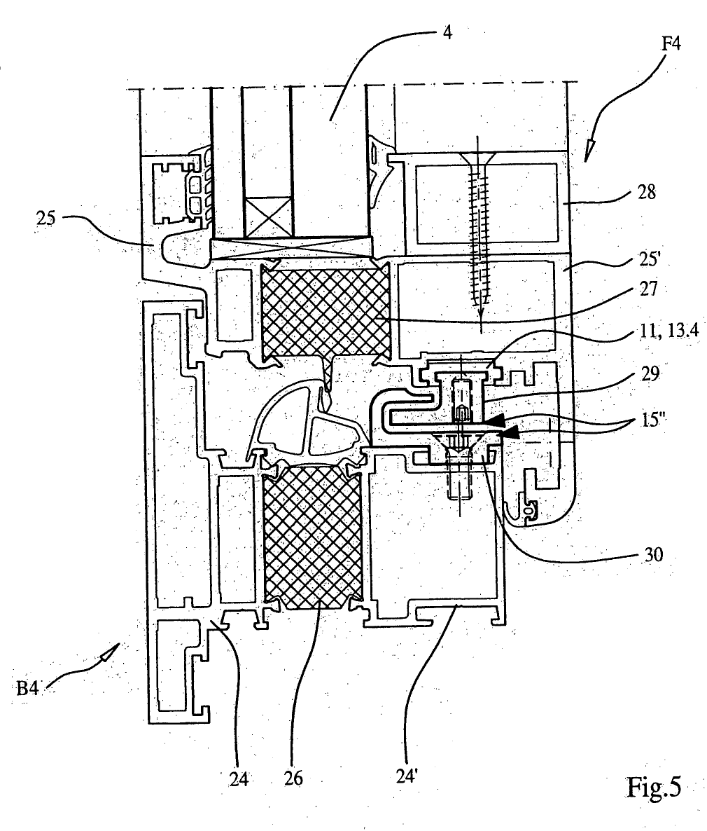

FIG. 5 a vertical section through a lower frame leg of the window in the closed state,

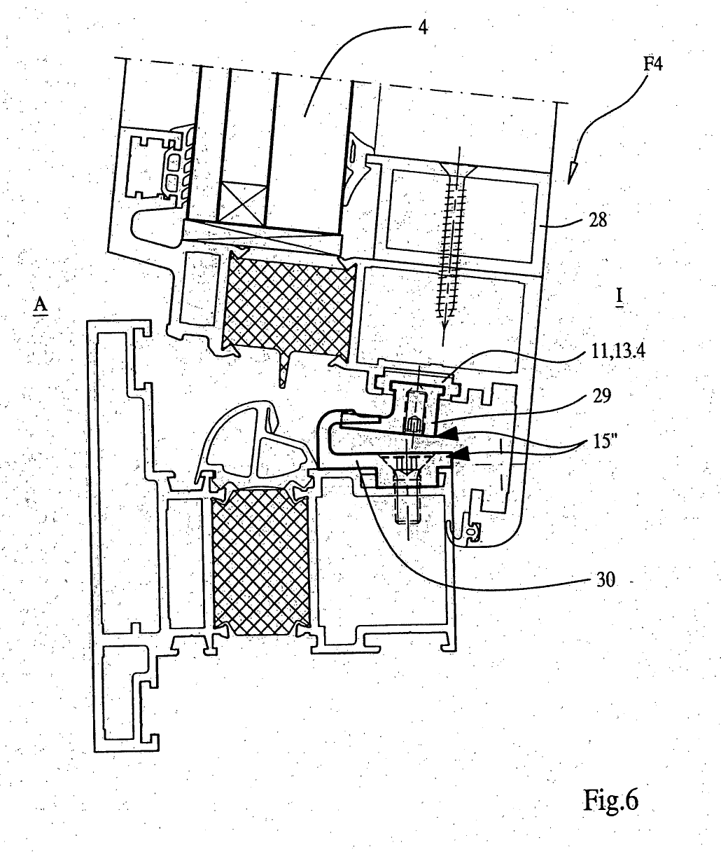

FIG. 6 a vertical section through a lower frame leg of the window in the tilted state,

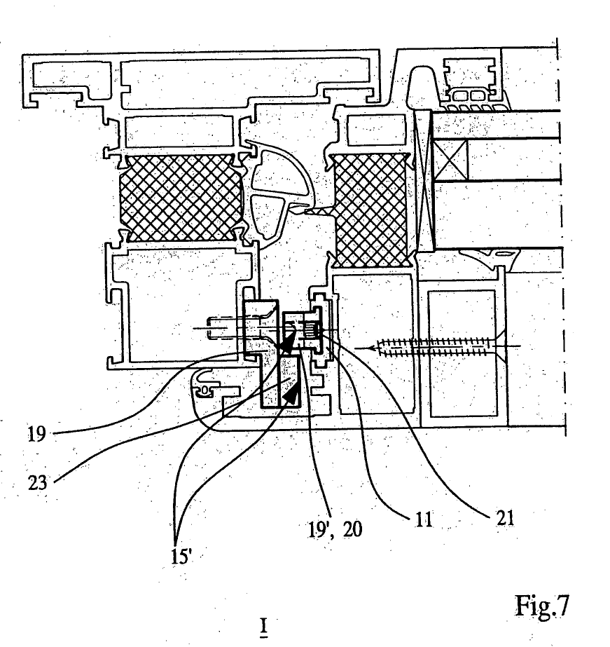

FIG. 7 a horizontal section through a lateral frame leg of the window in the closed state,

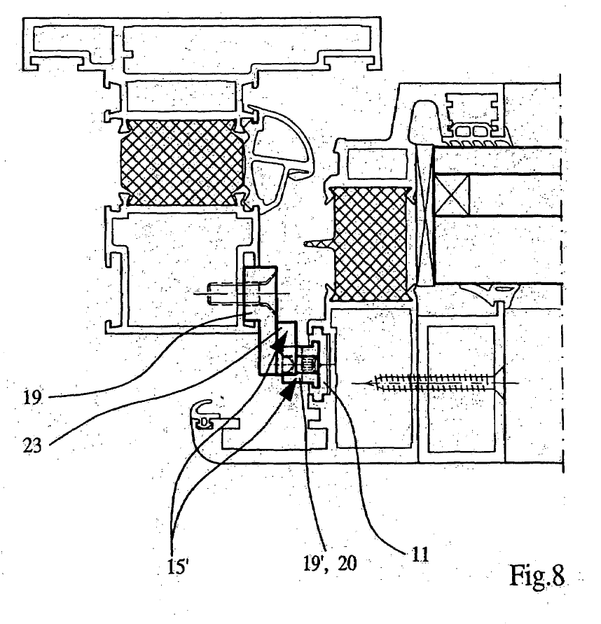

FIG. 8 a horizontal section through a lateral frame lying on the window in the tilted state,

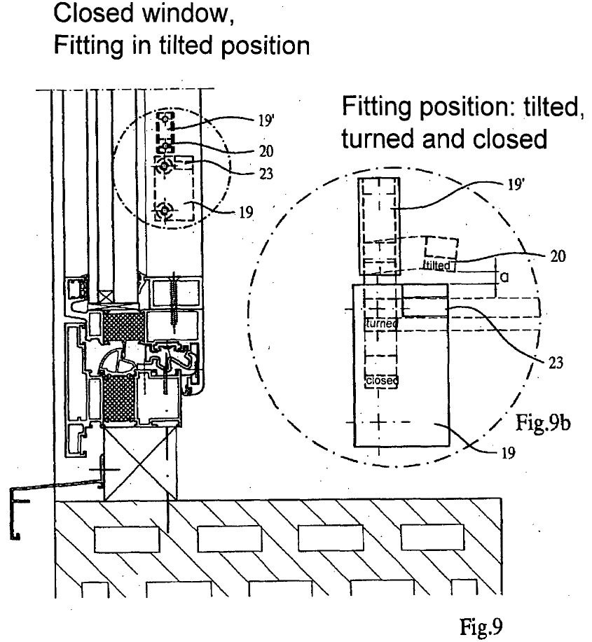

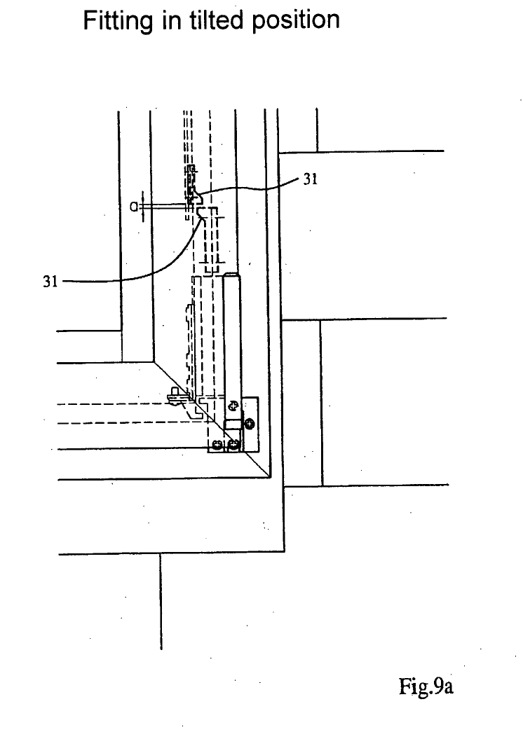

FIG. 9 a part of a vertical section of the window in the closed state,

FIG. 9a a view of the part of a corner area of the window from FIG. 9,

FIG. 9b a detail of the fitting position from FIG. 9,

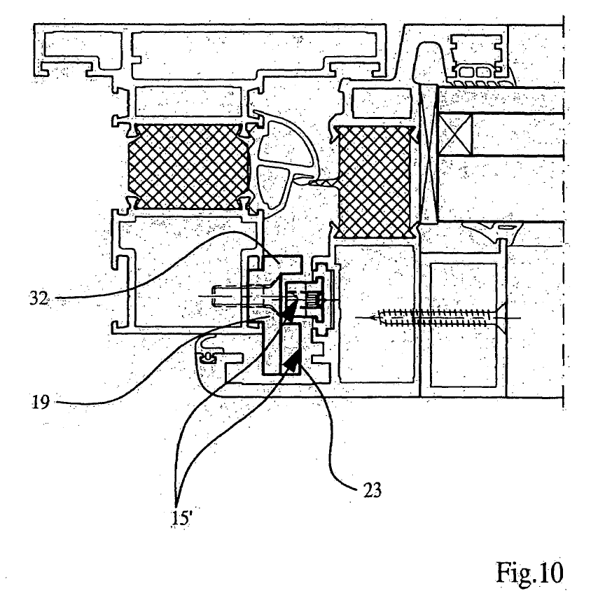

FIG. 10 a horizontal section of a lateral frame leg of a second window according to the present invention in the closed state,

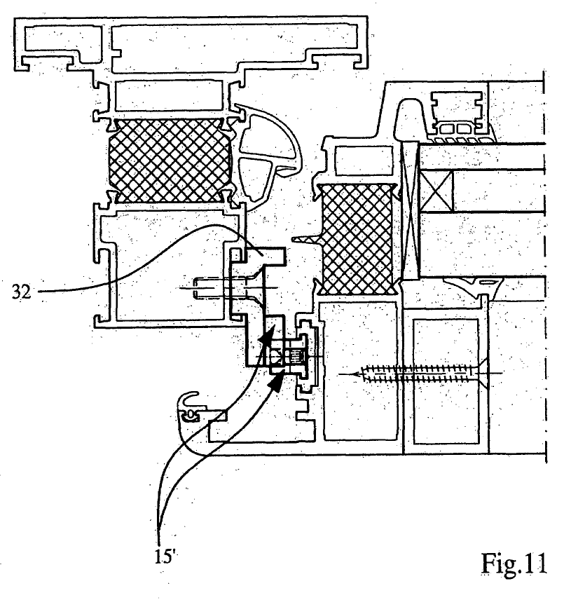

FIG. 11 a horizontal section of a lateral frame leg of the second window according to the present invention in the tilted state,

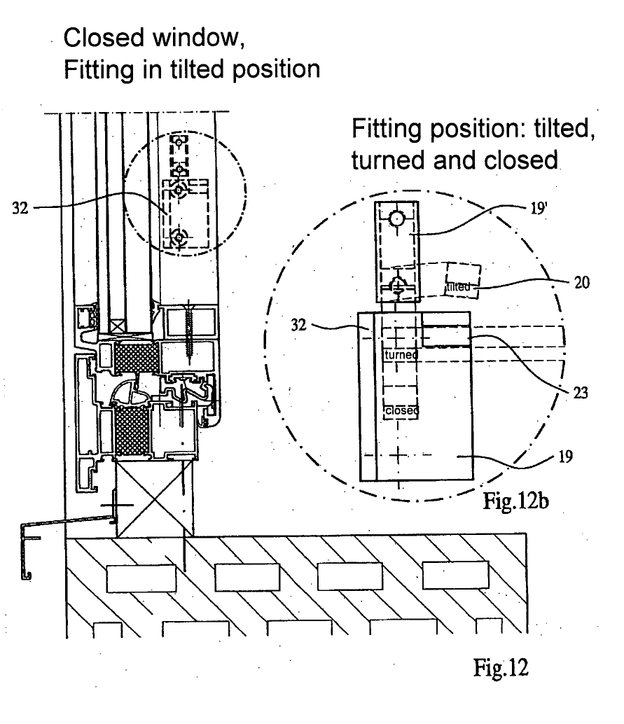

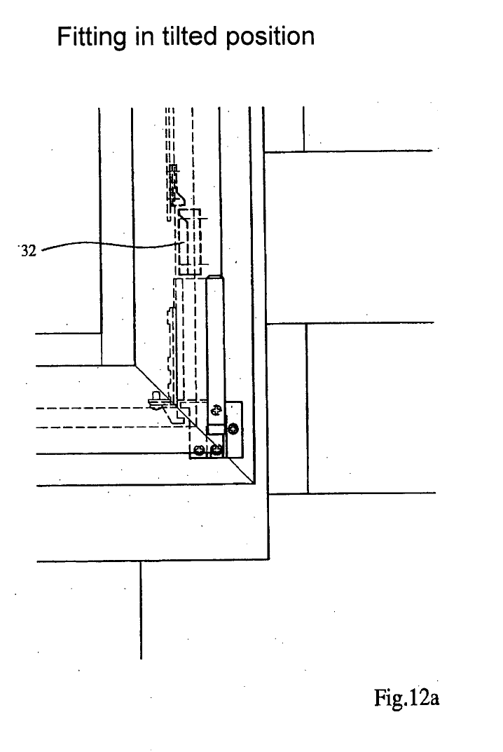

FIG. 12 a part of a vertical section of the second window according to the present invention in the closed state,

FIG. 12a a view of a part of a corner area of the window from FIG. 12,

FIG. 12b a detail of the fitting position from FIG. 12,

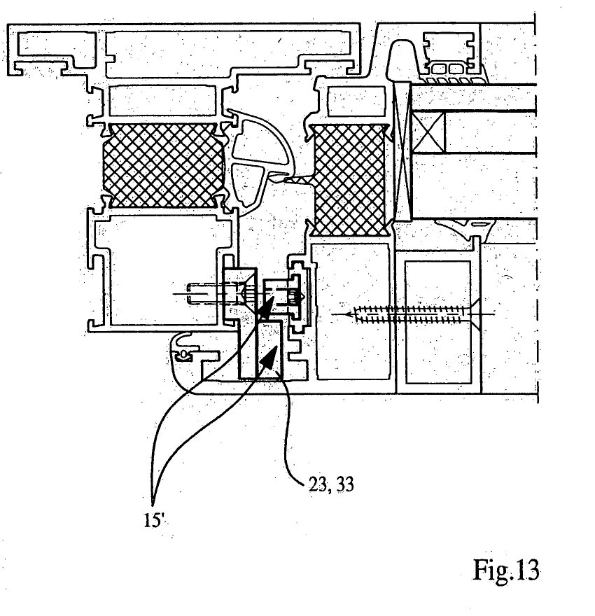

FIG. 13 a horizontal section through a lateral frame leg of a third window according to the present invention in the closed state,

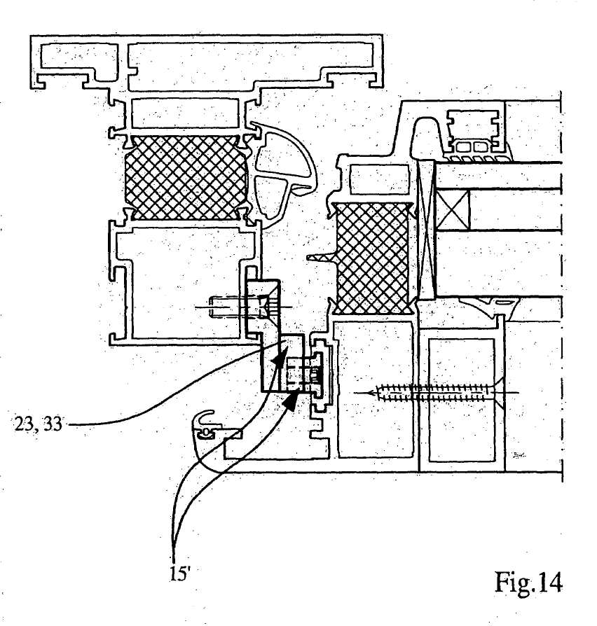

FIG. 14 a horizontal section through a lateral frame leg of a third window according to the present invention in the tilted state,

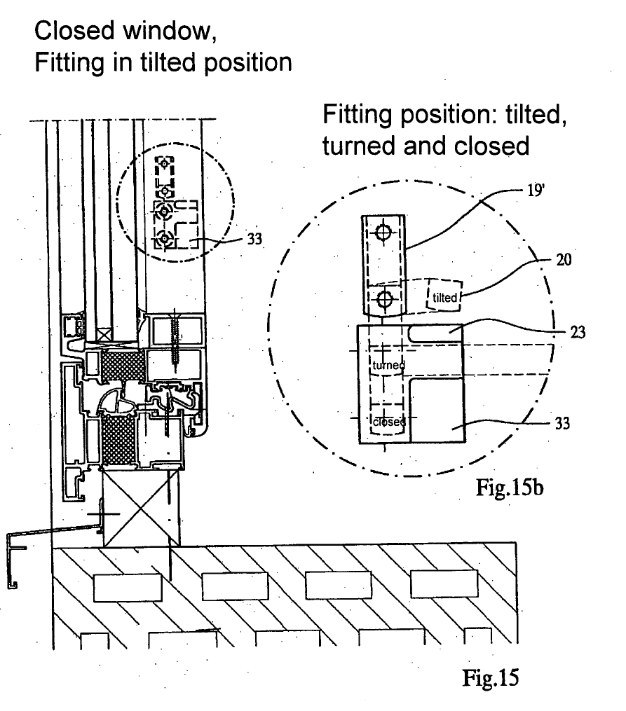

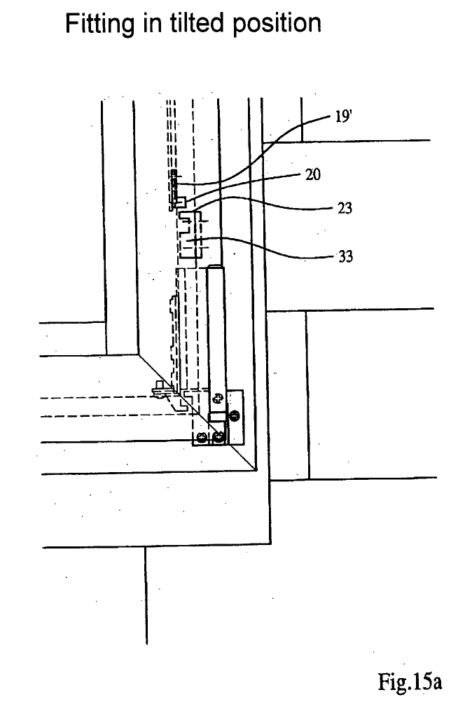

FIG. 15 a part of a vertical section of the third window according to the present invention in the closed state,

FIG. 15a a view of a part of a corner area of the window from FIG. 15, and

FIG. 15b a detail of the fitting position from FIG. 15.

FIG. 1 shows a first example of a window 1 according to the present invention in an external view. The window 1 has a frame 2, which is inserted into an opening of a building part G and permanently connected thereto by suitable fasteners, and a casement 3 accommodating a filling 4. The casement 3 and the frame 2 each comprise four legs F1, F2, F3, F4, B1, B2, B3, B4, two of which run horizontally F1, F4, B1, B4 and two of which run vertically F2, F3, B2, B3 in each case. The casement 3 is connected using hinges 16, 16′ and/or fitting parts to the frame 2, so that turning or tilting movements of the casement 3 are alternately made possible. To transfer the window 1 from a closed position 5 into an open position 7, 12 (turning or tilting movement) an actuating handle 17 is moved from its closed position either into a turning position (90°) or a tilting position (180°). The change of the position of the actuating handle 17 causes a displacement, corresponding to the rotation of actuating handle 17, of a connecting rod 11 illustrated by dashed lines, which runs around the circumference of the casement 3. The actuating handle is coupled to the connecting rod using a known handle gear. The connecting rod 11 is subdivided into four sections 13.1 through 13.4 of the connecting rod 11, which are assigned to the particular casement legs F1, F2, F3, F4 and attached thereto. The sections 13 of the connecting rod 11 are coupled to the corners of the casement 3 using force-transmitting corner deflectors 14, which are shown in FIG. 4. The mode of operation is generally known and will therefore not be explained further here. By displacing the connecting rod 11, locks 6 between frame 2 and casement 3 may be engaged or disengaged, the locks 6 on the casement legs F2, F4 assigned to the tilt axis or the turning axis, respectively, remaining locked—depending on the position of the actuating handle 17—so that tilting or turning of the casement 3 is made possible.

Two scissor hinges 8 are situated between the upper casement leg F1 and the upper frame leg B1, which are implemented as security scissor hinges 8 and delimit the opening angle when transferring the window from the closed position 5 into the tilted position 7. They are distinguished by an especially stable implementation. The security scissor hinges 8 are each connected at their ends via bolts and/or pins and/or a mushroom head to bearing elements 9, 9′ (FIG. 3), which are inserted into chambers 10, 10′ of the casement and frame legs F1, B1. The bearing element 9 connected to the casement leg F1 has a groove 18, which is open on one side, for guiding the scissor hinge bolt, in which this is guided when the casement is transferred from the closed position 5 into the tilted position 7.

To further increase the break-in security, various connecting rod blocks 15, 15′, 15″ are situated on all four casement legs F1, F2, F3, F4, which entirely prevent a forcible displacement of the individual sections 13 of the connecting rod 11 in the tilted position 7 of casement 3 and/or prevent displacement beyond that corresponding to the rotational position of the actuating handle 17. The connecting rod blocks 15, 15′, 15″ are differentiated as upper connecting rod blocks 15, lateral connecting rod blocks 15′, and lower connecting rod blocks 15″, and have differences in their construction and mode of operation. The modes of operation of the particular connecting rod blocks 15, 15′, 15″, which may comprise either one or two block elements, are discussed in the following figures.

FIG. 2 shows a vertical section through the window 1 according to the present invention from FIG. 1 in the closed state. The lateral connecting rod block 15′ of a vertical casement leg F2, F3, which has two block elements, which is illustrated in FIG. 7 in horizontal section, comprises a plate 19 permanently attached to the frame 2 and a plate 19′ attached to the connecting rod 11—illustrated in FIG. 2—which is provided with a lug 20. The plate 19′ is connected using set screws 21 to the connecting rod 11, so that it follows a displacement along the casement circumference in accordance with the rotation of actuating handle 17, like the connecting rod 11 itself. For the purpose of security, the set screws 21 are secured against dismounting using a ball hammered into the threaded hole. Securing by applying an adhesive or by drilling out a screw slot is alternatively possible. The plate 19, which is permanently attached to the frame 2 by two countersunk screws 22, has a projection 23 at an edge area. In the closed position 5 of the window 1, the lug 20 and the projection 23 are laterally offset to one another, so that the connecting rod 11 is freely displaceable around the circumference of the casement 3 and a relative movement may occur between the projection 23 of the fixed plate 19 and the lug 20 of the plate 19′ attached to the connecting rod 11, as occurs in the event of actuation of the actuating handle 17. The lateral connecting rod block 15′ is first activated when the window 1 is transferred from the closed position 5 into the tilted position 7, in that the position of the connecting rod 11 is changed in a direction approximately perpendicular to the plane of the pane. In this position, the connecting rod 11 may not be displaced downward in the vertical direction, since it is blocked by the projection 23 on the plate 19.

The lock 6 on the lower casement leg F4 comprises typical hooked locking elements 6′, 6″, which are permanently connected to the frame 2 and, in addition, are attached to the connecting rod 11 of the casement 3 and are displaceable along the tilt axis. In the closed state and in the tilted state, the lower locking elements 6′, 6″ engage in one another.

A vertical section of the window 1 in the tilted position 7 may be seen in FIG. 3. Bolts located at both ends of the security scissor hinges 8 engage in bearing elements 9, 9′, which are situated fixed in a chamber 10′ of the frame and are situated displaceably in a chamber 10 of the casement. In this way, stable mounting of the security scissor hinges 8, which are made entirely of stainless steel, in the frame elements is ensured.

The lateral connecting rod block 15′ visible in FIG. 3 has been activated by tilting the casement 3. The connecting rod 11 having the plate 19′ thereon, which is equipped with a lug 20, has been moved into alignment with the projection 23 located on the plate 19, by which forcible manipulation and/or forcible displacement of the connecting rod 11, by which complete opening of the window 1 may be achieved, are counteracted. The configuration of the lateral connecting rod block 15′ in the lower area of the casement leg F2, F3 is selected because of the small opening gap of the window 1 in the tilted position 7 provided there. Accordingly, uncovering the lateral connecting block 15′ and access thereto is made more difficult for unauthorized persons.

FIG. 4 shows a top view of the window 1 in the tilted position 7. The two security scissor hinges 8 in the upper part of the window 1 delimit the upper opening gap of the window 1. The connecting rod 11 is equipped on the upper casement leg F1 with two bearing elements 9, which are assigned to the security scissor hinges 8 and are provided with a groove 18, whose length is selected in such a way that it is only possible for the bolts or mushroom heads to slide out of the groove 18 in the nearly closed state of the casement 3. Furthermore, upper connecting rod blocks 15, which are implemented as rectangular plates and are attached using screws to the casement 3, are situated above the connecting rod 11. If the window 1 is located in the tilted position 7, it is only possible for an unauthorized person, after destroying the corner deflector 14, for example, to displace the connecting rod 11 or a section 13 of the connecting rod by the amount which corresponds to the distance of the upper connecting rod block 15 from the rear of the bearing element 9 in the position shown in FIG. 4, which is not sufficient to slide the mushroom head out of the groove 18. Even in the event of a closing movement by an unauthorized person from the outside, it is only possible with difficulty to guide the mushroom head of the security scissor hinge 8 out of the bearing element 9.

FIGS. 4a through 4c each show a vertical section through a window 1 according to the present invention in the tilted state having alternatively implemented security scissor hinges and/or their bearing elements. The security scissor hinge 8 illustrated in FIG. 4a has its mushroom head in a bearing element 9′″, which comprises a tubular profile, which is provided with an upper opening slot and is C-shaped in cross-section. The tubular profile is connected by a fastening screw 36, which passes through the connecting rod 11, to an insert in the form of a rectangular tubular part 40 in a chamber 10″ of the casement 3. The casement 3 is slotted for this purpose in the area of the displacement path of the connecting rod 11, so that the insert may follow the movement of the connecting rod 11. The chamber 10″ is located, in contrast to the chamber 10 of the casement profile from FIG. 3, not laterally next to the connecting rod, but rather below its bearing groove.

FIG. 4b shows a security scissor hinge 8, which is provided on its end facing toward the casement 3 with an extension 38 beyond the mushroom head. The extension 38 is covered by an edge strip 37 formed by the casement profile, which thus acts as a covering. The bearing element 9′″, which receives the mushroom head and is implemented as a tube, is connected on one end to the connecting rod 11 and on the other end to the casement 3 by a rectangular solid profile 34 and a plate 35, which acts as an insert. The extension 38 of the security scissor hinge 8 and the additional, massively implemented connection of the bearing element 9′″ to the casement 3 makes access to the security scissor hinge 8 and/or manipulation of its mounting extremely difficult.

The security scissor hinge 8 illustrated in FIG. 4c is implemented as narrower than that from FIG. 4b. The mounting of the mushroom head is performed analogously to that from FIG. 4b. Instead of an extension of the security scissor hinge 8 beyond the mushroom head, in FIG. 4c, the end of the security scissor hinge 8 is provided with a cover formed by a covering angle 37′, so that manipulation of the security scissor hinge 8 and its mounting is also made more difficult here.

FIGS. 5 and 6 show a vertical section through a lower frame leg of the window 1 having an embodiment of a lower connecting rod block 15″, once in the closed position and once in the tilted position. The frame 2 comprises two aluminum profiles 24, 24′, which are each distinguished by a chamber-like construction. An insulation profile 26 is provided to avoid thermal bridges and to connect the two aluminum profiles 24, 24′. The casement 3 also comprises two chamber-like aluminum profiles 25, 25′, one of which is situated toward the exterior and one of which is situated toward the interior. The two aluminum profiles 25, 25′ of the casement 3 are connected by an insulation profile 27. To fix the filling in its position, a glass holder strip 28 is placed in front of the filling 4 from the inside and attached using a screw in the aluminum profile 25′ of the casement, which is situated toward the interior. The inner aluminum profile 25′ of the casement has a C-shaped cross-section below the chamber, in which the connecting rod 11 is situated. The connecting rod 11 is also implemented as C-shaped and receives head areas of L-shaped pins 29 situated along the casement leg F4 in the clamp-like area which it forms itself. In addition to the fixing of the head areas of the pins 29 by the clamp-like area of the connecting rod 11, the pins 29 are connected using set screws to the connecting rod 11 and, analogously to the lug 20 of the lateral connecting rod block 15′, may follow a displacement around the casement circumference corresponding to the rotation of the actuating handle 17 like the connecting rod 11 itself. In the closed state of the window 1, the L-shaped pins 29 lie in cross-section inside an area formed by C-shaped projections 30, which are permanently attached to the frame 2 using screws. Pins 29 and projections 30 form the lower connecting rod block 15″, which is not activated when the window 1 is in the closed position 5. Upon transfer of the actuating handle 17 from the closed position 5 into the tilted position 7, the pins 29 of the connecting rod 11 are displaced, so that they come to rest offset to the projections of the frame leg B4 in the longitudinal direction of the casement leg F4. The L-shaped pins 29 of the connecting rod 11, which are displaced around the circumference, first come into a diagonal position when the casement is in the tilted position 7 shown in FIG. 6, due to which their end areas come into the plane of the C-shaped projections 30. Therefore, there is a meshed interlocking of the pins 29 with the projections 30 and a displacement of the connecting rod 11 and/or the section of the connecting rod 13.4 is prevented.

The horizontal sections through a lateral frame leg of the window 1 illustrated in FIGS. 7 and 8 show the mode of operation of the lateral connecting rod block 15′, previously illustrated in FIGS. 2 and 3, upon opening of the window 1. The connecting rod 11, which is implemented as C-shaped, lies in a formfitting way in an area which is also implemented as C-shaped by the aluminum profile of the casement 3. The lug 20 of the lateral connecting rod block 15′ situated on the plate 19′ engages in the area of the connecting rod 11 which is implemented as C-shaped and is additionally connected thereto using a set screw 21, so that the connecting rod 11 having the lug 20 located on the plate 19′ follows a displacement around the casement circumference corresponding to the rotation of the actuating handle 17. The plate 19 permanently attached to the casement 2 has a projection 23 on its edge area. In the closed state (FIG. 7) of the casement 3, the lug 20 and the projection 23 lie laterally neighboring one another, so that the connecting rod 11 is freely displaceable around the circumference of the casement 3 and a relative movement may occur between the fixed plate 19 having its projection 23 and the lug 20. Only when the casement 3 is transferred from the closed position 5 into the tilted position 7, as illustrated in FIG. 8, is the connecting rod 11 first moved around the circumference of the casement 3 in relation thereto and subsequently, together with the casement 3, approximately perpendicularly to the filling plane in the transverse direction of the window 1. The lug 20 of the connecting rod 11 attached to the plate 19′ thus reaches a position directly neighboring the projection 23 and a movement of the connecting rod 11 around the circumference of the casement 3 is blocked.

FIG. 9 shows an enlarged part of a vertical section of the window 1 in the closed position analogous to FIG. 2, a lateral connecting rod block 15′ being more clearly recognizable. The detail illustrated enlarged once again in FIG. 9b shows the fitting position of the lateral connecting rod block 15′ in the tilted, turned, and closed positions. It may be seen that the connecting rod 11 having the plate 19′ attached thereto, which is equipped with a projecting lug 20, is located next to the projection 23 attached to the plate 19 of the frame 2 in the turned and closed positions. In the tilted position, however, the casement 3 is moved approximately perpendicularly to its filling 4, by which the lug 20 on the connecting rod 11, which forms a part of the lateral connecting rod block 15′, arrives in front of the projection 23. It is now only possible to displace the connecting rod 11 downward in the vertical direction over a length which corresponds to the distance of the lug in the tilted position from the projection and a minimal residual path a. This residual path a ensures sufficient freedom of movement in the tilted position 7 of the fitting. FIG. 9a shows the view of a part of a corner area of the window 1 from FIG. 9 in the tilted position 7. The geometry of the two blocking elements, lug 20 and projection 23, is clearly recognizable. The lug 20 and the projection 23 are implemented as broader on their ends facing toward one another, so that these areas block a displacement of the lug 20 around the circumference of the casement 3 beyond the residual path a in the tilted position 7. The diagonal faces 31 of the two blocking elements which are implemented ensure the rotational mobility of the casement 3 in the rotated position of the fitting.

FIGS. 10 and 11 show a horizontal section of a lateral frame leg of a second window according to the present invention, once in the closed state and once in the tilted state. Except for a differing embodiment of the plate 19 located on the frame 2, FIGS. 10 and 11 correspond to FIGS. 7 and 8. The plate 19 has, in addition to the projection 23 on its opposite side, a second projection 32, which offers further protection from manipulation as a shield element. It is made significantly more difficult by the second projection 32 for an unauthorized person to reach the fasteners (screws) of the lateral connecting rod block 15′ if a window is in the tilted position 7, for example.

In FIGS. 12 through 12b, the lateral connecting rod block from FIGS. 10 and 11 is illustrated analogously to FIGS. 9 through 9b. The second projection 23 extends over the entire length of the plate 19.

FIG. 13 through 15b show a further embodiment of the lateral connecting rod block 15′ analogous to FIGS. 10 through 12b. The plate 19 of the lateral connecting rod block 15′ is equipped with a further projection 33 in addition to the projection 23, which lies at a distance below the projection 23, so that increased break-in retardance is also achieved in the closed position 5 of the window 1, since the connecting rod block 15′ additionally acts as a lock in this position. In the detail of the fitting position shown in FIG. 15b, it may be seen especially well that in the closed position 5 of the window 1, a lateral displacement and/or forcible manipulation of the connecting rod 11 is made significantly more difficult by the additional projection 33. A forcible removal of the entire casement 3 from the frame 2 is prevented in the closed position 5, because a lateral movement of the lug 20 attached to the plate 19′ of the connecting rod 11 is blocked by the projection 33.

### LIST OF REFERENCE NUMERALS

1 window

2 frame

3 casement

4 filling

5 closed position

6 lock

6′ locking element

6″ locking element

7 tilted position

8 scissor hinge

9 bearing element

9′ bearing element

9″ bearing element

9′″ bearing element

10 chamber

10′ chamber

10″ chamber

11 connecting rod

12 open position

13.1 section

13.2 section

13.3 section

13.4 section

14 corner deflector

15 upper connecting rod block

15′ lateral connecting rod block

15″ lower connecting rod block

16 tilt-turn hinge

16′ hinge

17 actuating handle

18 groove

19 plate

19′ plate

20 lug

21 set screw

22 countersunk screw

23 projection

24 aluminum profile

24′ aluminum profile

25 aluminum profile

25′ aluminum profile

26 insulation profile

27 insulation profile

28 glass holder strip

29 pin

30 projection

31 diagonal face

32 projection

33 projection

34 rectangular solid profile

35 plate

36 fastener screw

37 edge strip

37′ cover angle

38 extension

40 rectangular tubular part

a residual path

G building part

B1 frame leg

B2 frame leg

B3 frame leg

B4 frame leg

F1 casement leg

F2 casement leg

F3 casement leg

F4 casement leg

1. A security window (1) or door in a burglar-retardant embodiment, having a frame (2), which is permanently connectable to a building part (G), and a casement (3), which is mounted so it may be turned and tilted therein and is provided with a filling (4), and which is connected to the frame (2) in its closed position (5) via locks (6) and, in its tilted position (7), at least in the area of the casement leg (F4) assigned to the tilt axis, is also connected to the frame (2) via locks (6) and in the area of the diametrically opposite casement leg (F1) via at least one scissor hinge (8), the locks (6) being situated in diametrically opposing pairs on the casement (3) and the frame (2) and being able to be engaged and disengaged using a connecting rod (11), which is mounted in the casement (3) and is displaceable parallel to the plane of the filling (4), in the closed position (5) of the casement (3), one end of the scissor hinge (8) being removable by displacing the connecting rod (11) from the bearing element (9, 9′, 9′″) on the casement (3) or on the frame (2), so that the casement (3) is turnable out of its closed position (5) around a turn axis perpendicular to the tilt axis into an open position (12), furthermore, sections (13.1 through 13.4) of the connecting rod (11), which are situated on neighboring casement legs (F1 through F4), being frictionally coupled to one another via corner deflectors (14), wherein at least one connecting rod block (15, 15′, 15″) on at least one casement leg (F1 through F4) prevents a displacement of the assigned section (13.1 through 13.4) of the connecting rod (11) when the casement (3) is in the tilted position (7), or only allows a displacement path which is required in the closed position (5) of the casement (3) to disengage the scissor hinge (8) and a bearing element (9, 9′, 9′″) on the casement (3) or the frame (2).

2. The security window (1) or door according to claim 1, wherein the at least one connecting rod block (15, 15′, 15″) comprises a block element coupled to a section of the connecting rod and a block element which works together with an assigned frame leg and is permanently connected thereto, the block elements being able to be disengaged by transferring the casement (3) from the tilted position (7) into the closed position (5), so that the connecting rod (11) is displaceable.

3. The security window (1) or door according to claim 2, wherein at least one block element which is permanently connected to a vertical frame leg (B2, B3) projects beyond the plane of the frame (2) facing toward an interior and is covered in the closed position (5) of the casement (3) by an edge strip of the assigned vertical casement leg (F2, F3).

4. The security window (1) or door according to claim 1, wherein at least the section (13.1) of the connecting rod (11) which is assigned to the casement leg (F1) on which at least one security scissor hinge (8) is situated is at least partially covered by a connecting rod block (15).

5. The security window (1) or door according to claim 1, wherein the connecting rod (11) is covered in the area between two corner deflectors (14) using at least one connecting rod block (15, 15′, 15″), which is permanently connected to the casement (3), in such a way that the connecting rod (11) is displaceable in relation to the casement (3) under the connecting rod block (15, 15′, 15″).

6. The security window (1) or door according to claim 1, wherein the connecting rod block (15) is L-shaped in cross-section and is connected in the area of a short L-leg to the casement leg (F1) lateral neighboring the connecting rod (11), preferably on the side facing toward the exterior (A) of the building, and the long L-leg covers the connecting rod (11) over its entire width.

7. The security window (1) or door according to claim 1, wherein the at least one connecting rod block (15, 15′, 15″) also prevents a displacement of the casement (3) in a direction parallel to the plane of the filling (4) and perpendicular to the assigned connecting rod (11) in the tilted position (7) of the casement (3).

8. The security window (1, 1′) or door according to claim 1, wherein the end of the scissor hinge (8) facing toward the casement (3) is covered by a cover connected to the casement (3).

9. The security window (1, 1′) or door according to claim 1, wherein the scissor hinge (8) is implemented as a security scissor hinge (8), bearing elements (9, 9′, 9′″) of the security scissor hinge (8) being connected to inserts in chambers (10, 10′) of both the casement (3) and also the frame (2).
